(19) United States
(12) Patent Application Publication
(10) Pub. No.: US 2006/0216129 A1
(43) Pub. Date: Sep. 28, 2006

(54) Loose-proof screw bolt

(76) Inventor: Chen-Mao Lin, Kuei Jen Shiang (TW)

Correspondence Address: LEONG C LEI, PMB # 1008, 1867 YGNACIO VALLEY ROAD, WALNUT CREEK, CA, 94598, US

(21) Appl. No.: 11/087,584

(22) Filed: Mar. 24, 2005

(51) Int. Cl. F16B 39/24

(52) U.S. Cl. 411/161

(57) ABSTRACT

A loose-screw bolt is disclosed. The screw bolt comprises a pad, a bolt and a nut, wherein the pad is a flat surface and the flat surface is provided with at least a V-shaped slot arranged radially. The V-shaped slot includes a sloping face and a vertical wall, and the sloping face is along the tightening direction of the bolt. When the screw nut rotates counter-clockwise, the frictional force of the pad at the sloping face and the surface of a work piece will increase with respect to the anti-clockwise rotation of the screw nut.

### BACKGROUND OF THE INVENTION

(a) Technical Field of the Invention

The present invention relates to a loose-proof screw bolt, and in particular, a single direction wedge-shaped teeth structure between the screw nut and a pad and a V-shaped slot arranged radially such that the screw nut can be tighten easily but not easily loosen.

(b) Description of the Prior Art

FIGS. 1A, 1B, 2A and 2B show conventional loosen-proof bolt having a bolt 11, a pad 12 and a screw nut 13. The two faces of the pad 12 are provided with at least, a first uni-direction wedge-shaped teeth 121 and at least a sharp stripe 122. However, these conventional loosen-proof screw bolt have the following drawbacks:
1. When the screw nut is to be unscrewed, the external edge contact area is small and therefore the action force becomes larger, the pad 12 or the screw nut 13 are deformed and thus the screw nut is loosen.
2. The loosen-proof screw bolt of FIG. 2A has lower contact area and similarly the pad 12 or the screw nut 13 is deformed, and thus the screw nut is loosen.
3. The pad of the conventional screw bolt is formed with scratched mark.
4. If the work piece 21 is harder than the pad 12, the sharp stripe 122 can be easily damaged, and therefore the screw nut 13 can be dislocated when the screw nut is unscrewed.

### SUMMARY OF THE INVENTION

The primary purpose of the present invention is to provide a loose-proof screw bolt comprising a pad, a bolt and a nut, wherein the pad is a flat surface and the flat surface is provided with at least a V-shaped slot arranged radially.

Still another object of the present invention is to provide a loose-proof screw bolt, wherein the V-shaped slot includes a sloping face and a vertical wall, and the sloping face is along the tightening direction of the bolt.

Yet another object of the present invention is to provide a loose-proof screw bolt, wherein the vertical wall of the V-shaped slot is used as a force point, which enhances resistance between the pad and the work piece.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1A is a perspective view of a conventional screw bolt.

FIG. 1B is a schematic view of the single direction wedge-shaped teeth engagement of FIG. 1A.

FIG. 2A is a schematic view of a conventional screw bolt structure.

FIG. 2B is a view showing the relationship of the nut of FIG. 2A and the sloping face of the pad.

FIG. 3 is a perspective view in accordance with the present invention.

FIG. 4 is a schematic view showing the direction of the action force at the two sides of the pad of the present invention.

FIG. 5 is a schematic view showing the V-shaped slot formed into protruded mark on the surface of the work piece.

FIG. 6 is a perspective view of another preferred embodiment in accordance with the present invention.

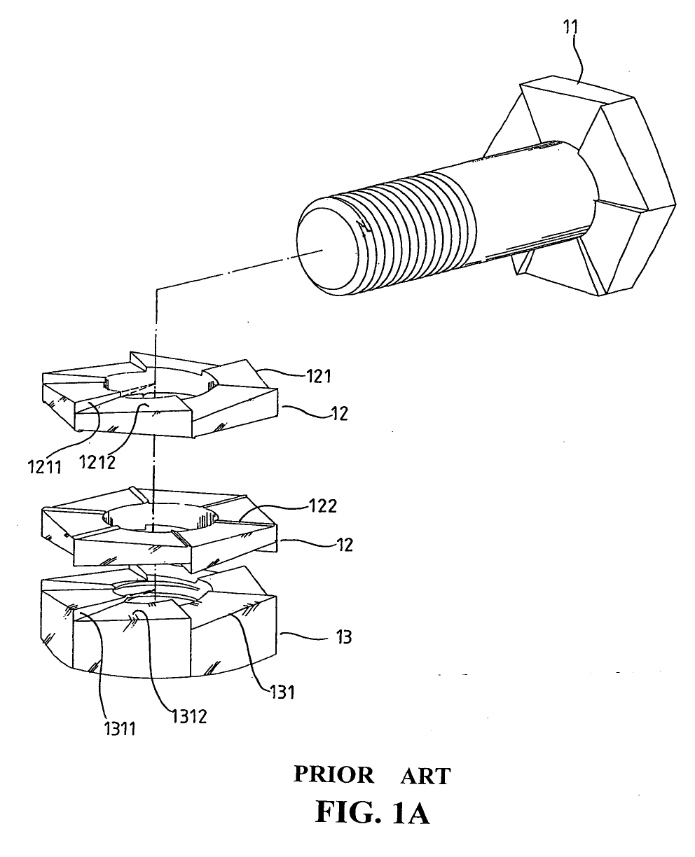

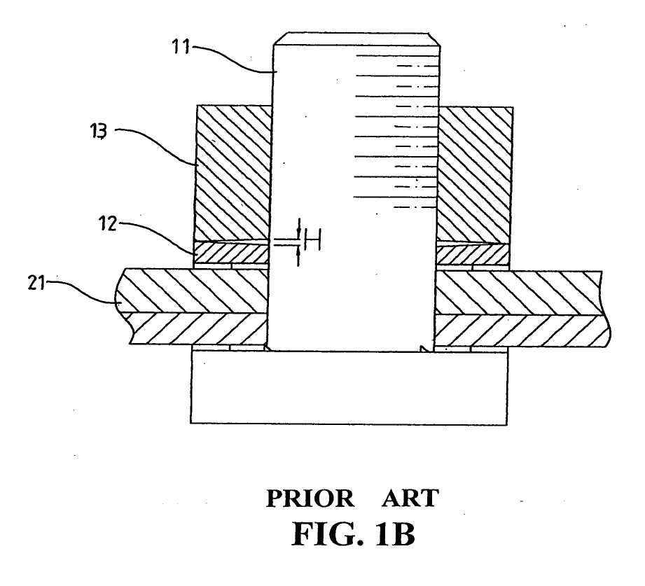

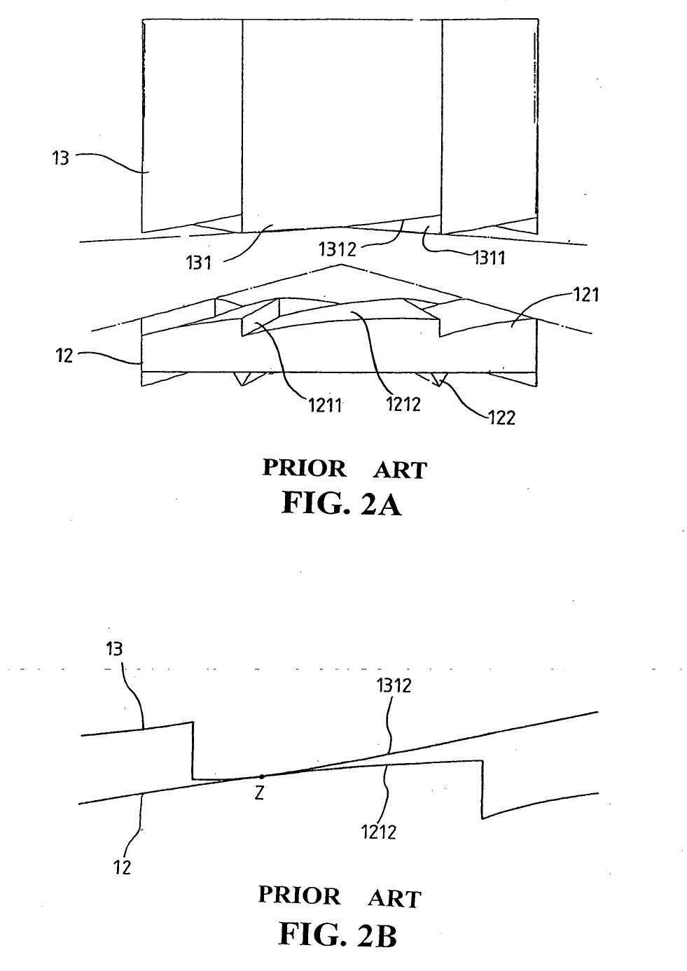

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

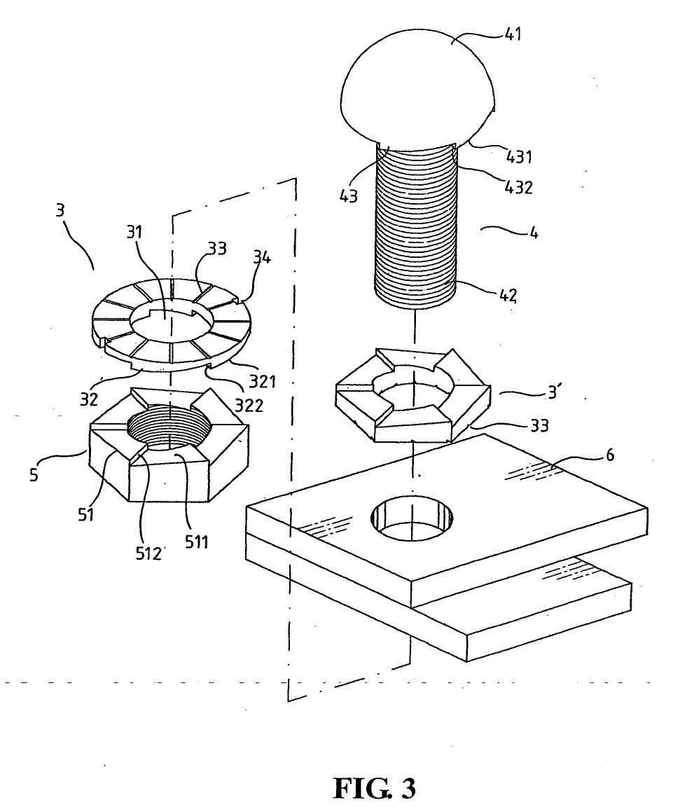

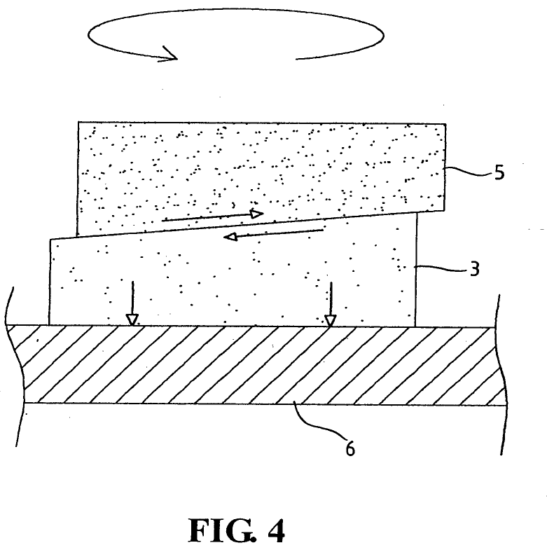

Referring to FIG. 3, there is shown a loose-proof screw bolt comprising a pad 3, a bolt 4, and a nut 5. The pad 3 has a flat surface, and the center of the flat surface has a through hole 31, and the circular pad 3 has a shape larger than the screw nut, or the similar hexagonal shaped pad 3′. The circular pad 3 at least has a recess 34. One face of the pad is provided with at least a single direction wedge-shaped tooth 32 and the other face is flat. The flat face is provided with at least a V-shaped slot 33 arranged radially. The single direction wedge tooth 32 includes a sloping face 321 and a vertical top face 322. The sloping face 321 under the similar center of the circle the heights of the outer edge and the inner edge are similar. The V-shaped slot 33 includes a sloping face 331 and a vertical wall 332, and the sloping face 331 is along the tightening direction of the screw bolt.

The screw bolt 4 includes a head 41 and a shaft 42, and the head 41 is hexagonal, cylindrical and semi-spherical. The bottom face of the head 41 is formed into a second single direction wedge teeth 43 corresponding to the first single direction teeth 32 of the pad 3. The second single direction wedge teeth 43 includes a sloping face 431 and a vertical top face 432, and the sloping face 431 at the same center of circle the heights of the outer edge and the inner edge are the same.

The screw nut 5 corresponding to the pad 3 has a corresponding third single direction wedge teeth 51, and the third single direction wedge teeth 51 includes a sloping face 511 and a vertical top face 512, the external edge and the inner edge of the sloping face 511 at the same center of circle have the same height.

The screw bolt 4 passes through the pad 3′ and the locking piece 6 and mounted with the pad 3 and the screw nut 5 so as to lock the work piece. The screw nut 5 is engaged with the top face 322 of the single direction wedge-shaped teeth 32 with the top face 512 of the third single direction wedge teeth 51 so that the entire bolt is rotated. The contact face between the pad 3 and the work piece 6 is flat and the sloping face 331 direction of the V-shaped slot 33 is similar to that of tightening, thus the pad 3 can be easily tighten. Without protrusion structure, the surface of the piece 6 will not be damaged. Beside the flat contact of the pad 3 and the piece 6, the contact between the two elements is stable.

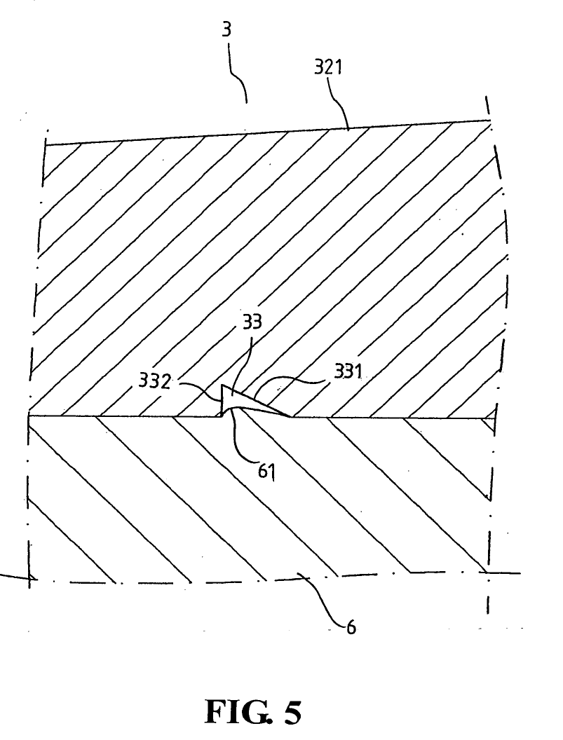

When the nut 5 reverses, the nut 5 cannot drive the pad 3, and therefore the sloping face 321, 511 will slide with each other. That is, two different directions force is obtained. That is a frictional stress and a stress exerted by the pad 3 onto the surface of the piece 6. The contacts of the two sloping faces 321, 511 are flat and when an angle is rotated a maximum area of contact is obtained. Thus, the frictional stress of the two sloping faces will increase with the increase of reverse direction of the screw nut 5, which forms the resistance to loosing of the screw nut 5. In addition, there is a larger contact surface area between the two sloping faces, the pressure of the two single direction wedge shape teeth 52, 51 is smaller, and this will eliminate the deformation. In addition, the surface of the pad 3 and the work piece is larger, when the screw nut 5 rotates, a larger frictional force resistance is formed, particularly, the stress formed on the work piece. The V-shaped slot 33 will form with a protruded mark 61 on the surface of the work piece (as shown in FIG. 5). The protruded mark 61 is a force point for the vertical wall 332 of the V-shaped slot 33. This will increase the sliding resistance of the pad 3 on the work piece 6.

If the screw nut 5 is to be unscrewed, the friction force of the sloping face and the work piece face will be formed, in particular, the deformation of the single direction wedge shape teeth 32, 51 is reduced, and with the resistance of the protruded mark 61, the unscrewing of the screw nut 5 is difficult. Thus, the present structure prevents loosening of the screw nut.

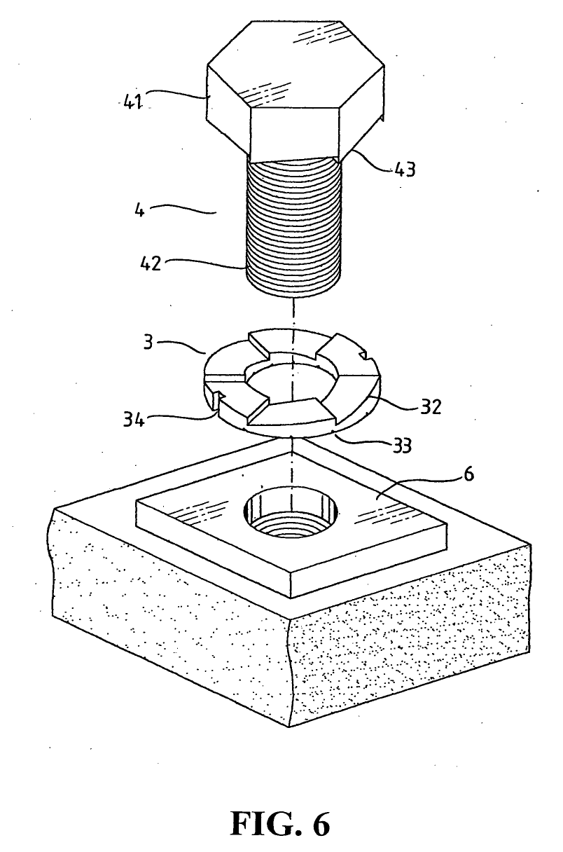

Referring to FIG. 6, there is shown another preferred embodiment. The head is hexagonal, if the screw bolt 4 is not needed, the screw bolt 4, the pad 3, the work piece are in sequence, mounted onto a main body. Thus, unless a special tool is used and corresponding to the head and the pad, otherwise the screw nut is not easily unscrewed.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-4. (canceled)

5. A loose-proof screw bolt comprising:
a first circular pad having a first side, a center through hole, and a circumferential edge, said circumferential edge having at least a recess, said first side being flat and provided with at least a radial V-shaped slot, said first circular pad having a second side provided with at least a single direction wedge-shaped tooth which includes a vertical face and a sloping face, said V-shaped slot including a sloping face and a vertical wall;
a second circular pad having a first side, a center through hole, and a circumferential edge, said circumferential edge of said second circular pad having at least a recess, said first side of said second circular pad being flat and provided with at least a radial V-shaped slot, said second circular pad having a second side provided with at least a single direction wedge-shaped tooth which includes a vertical face and a sloping face, said V-shaped slot of said second circular pad including a sloping face and a vertical wall, said first side of said first circular pad being arranged opposite to said first side of another one of said second circular pad;
a nut having a top provided with at least a third single direction wedge tooth which has a sloping face and a vertical face and is engageable with said single direction wedge-shaped tooth of said second circular pad; and
a bolt having a shaft and a head at an upper end of said shaft, said head having a bottom face provided with a least a second single direction wedge tooth which has a vertical face and a sloping face and is engageable with said single direction wedge tooth of said first circular pad, said bolt extending through said first circular pad, a working piece and said second circular pad to threadedly engage with said nut.
